(19) United States
(12) Patent Application Publication
(10) Pub. No.: US 2020/0007213 A1
(43) Pub. Date: Jan. 2, 2020

(54) METHOD OF CSI REPORTING

(71) Applicant: NTT DOCOMO, INC., Tokyo (JP)

(72) Inventors: Yuichi Kakishima, Tokyo (JP); Chongning Na, Tokyo (JP); Huiling Li, Tokyo (JP); Huiling Jiang, Tokyo (JP); Satoshi Nagata, Tokyo (JP)

(73) Assignee: NTT DOCOMO, INC., Tokyo (JP)

(21) Appl. No.: 16/482,934

(22) PCT Filed: Feb. 1, 2018
(86) PCT No.: PCT/US2018/016462

§ 371 Date: Aug. 1, 2019

Related U.S. Application Data
(60) Provisional application No. 62/454,514, filed on Feb. 3, 2017.

(51) Int. Cl. H04B 7/06; H04L 5/00; H04W 72/04

(52) U.S. Cl. CPC H04B 7/0626; H04B 7/0695; H04W 72/0413; H04W 72/046; H04L 5/0057

(57) ABSTRACT

A method of Channel State Information (CSI) reporting in a wireless communication system includes performing, with a user equipment (UE), advanced CSI reporting based on a high resolution CSI feedback scheme. The advanced CSI reporting includes a beam index that identifies each of beams and amplitude of the beam corresponding to the beam index. The performing performs the advanced CSI reporting using a Physical Uplink Control Channel (PUCCH) format 3/4/5. The beam index and the amplitude are located in the PUCCH format 3/4/5. The performing performs first advanced CSI reporting and performs second advanced CSI reporting after performing the first advanced CSI reporting. The first advanced CSI reporting includes one of the beam index and the amplitude. The second advanced CSI reporting includes the beam index or the amplitude that is not included in the first advanced CSI reporting.

### TECHNICAL FIELD

The present invention generally relates to a method of CSI reporting

### BACKGROUND ART

In conventional Channel State Information (CSI) feedback schemes, unnecessary feedback overhead may be incurred by high resolution CSI feedback. Furthermore, in the conventional CSI feedback schemes, inaccurate beam pattern selection and beam number selection may cause poor performance. However, the high resolution CSI feedback scheme has not been determined in the Long Term Evolution (LTE)/New Radio (NR) standards.

### SUMMARY OF THE INVENTION

One or more embodiments of the present invention relate to a method of Channel State Information (CSI) reporting in a wireless communication system that includes performing, with a user equipment (UE), advanced CSI reporting based on a high resolution CSI feedback scheme. The advanced CSI reporting includes a beam index that identifies each of beams and amplitude of the beam corresponding to the beam index.

One or more embodiments of the present invention relate to a method of CSI reporting in a wireless communication system that includes performing, with a UE, CSI reporting to a BS based on a normal CSI feedback scheme or advanced CSI reporting based on a high resolution CSI feedback scheme. The normal CSI feedback scheme and the high resolution CSI feedback scheme is switched.

Other embodiments and advantages of the present invention will be recognized from the description and figures.

### BRIEF DESCRIPTION OF THE DRAWINGS

FIG. 1 is a diagram showing a configuration of a wireless communication system according to one or more embodiments of the present invention.

FIG. 2 is a diagram showing an example of a PUCCH format used for CSI reporting for high resolution CSI feedback according to one or more embodiments of the present invention.

FIG. 3 is a diagram showing an example of a PUCCH format used for CSI reporting for high resolution CSI feedback according to one or more embodiments of the present invention.

FIG. 4 is a diagram showing an example of a PUCCH format used for CSI reporting for high resolution CSI feedback according to one or more embodiments of the present invention.

FIGS. 5A-5E are tables showing the PUCCH reporting type payload size per PUCCH reporting mode and mode state for the high resolution CSI feedback according to one or more embodiments of the present invention.

FIG. 6 is a diagram showing a method of selecting beams with a staggered pattern according to one or more embodiments of the present invention.

FIG. 7 is a diagram showing a method of selecting beams with a high selection frequency according to one or more embodiments of the present invention.

FIG. 8 is a diagram showing an example of a method of restricting oversampling factor and antenna ports combinations according to one or more embodiments of the present invention.

FIG. 9 is a diagram showing an example of extended Rel.13 LTE beam pattern selection parameter according to one or more embodiments of the present invention.

FIG. 10 is a diagram showing an example of new definition of codebook parameter CodebookConfig according to one or more embodiments of the present invention.

FIG. 11 is a diagram showing an example of a feedback procedure without beam pattern selection according to one or more embodiments of the present invention.

FIG. 12 is a diagram showing an example of a feedback procedure with beam pattern selection according to one or more embodiments of the present invention.

FIG. 13 is a diagram showing an example of a feedback procedure with beam pattern selection according to one or more embodiments of the present invention.

FIG. 14 is a diagram showing a schematic configuration of a BS according to one or more embodiments of the present invention.

FIG. 15 is a diagram showing a schematic configuration of a UE according to one or more embodiments of the present invention.

### DETAILED DESCRIPTION OF EMBODIMENTS

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

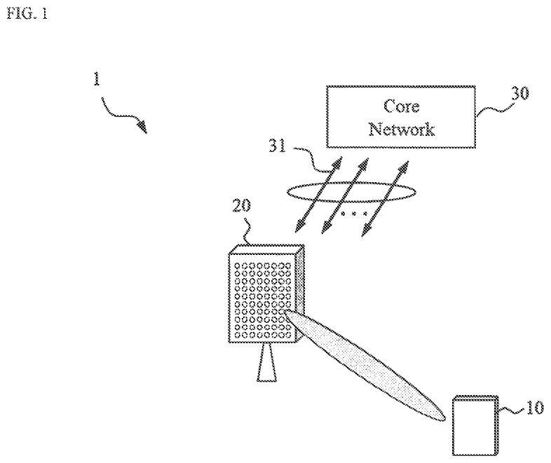

FIG. 1 is a wireless communications system 1 according to one or more embodiments of the present invention. The wireless communication system 1 includes a user equipment (UE) 10, a base stations (BS) 20, and a core network 30. The wireless communication system 1 may be a New Radio (NR) system. The wireless communication system 1 is not limited to the specific configurations described herein and may be any type of wireless communication system such as an LTE/LTE-Advanced (LTE-A) system.

The BS 20 may communicate uplink (UL) and downlink (DL) signals with the UE 10 in a cell of the BS 20. The DL and UL signals may include control information and user data. The BS 20 may communicate DL and UL signals with the core network 30 through backhaul links 31. The BS 20 may be Evolved NodeB (eNB).

The BS 20 includes antennas, a communication interface to communicate with an adjacent BS 20 (for example, X2 interface), a communication interface to communicate with the core network 30 (for example, S1 interface), and a CPU (Central Processing Unit) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous BSs 20 may be disposed so as to cover a broader service area of the wireless communication system 1.

The UE 10 may communicate DL and UL signals that include control information and user data with the BS 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

In one or more embodiments of the present invention, the BS 20 may transmit Channel State Information Reference Signals (CSI-RS) to the UE 10. The UE 10 may perform CSI reporting as CSI feedback in response to the received CSI-RSs.

The wireless communication system 1 according to one or more embodiments of the present invention supports two types of the CSI feedback scheme, which are normal CSI feedback and high resolution CSI feedback. The normal CSI feedback may be referred to as legacy CSI feedback or low resolution CSI feedback. The CSI reporting for the high resolution CSI feedback may be referred to as advanced CSI reporting.

The CSI reporting in the normal and high resolution CSI feedback includes a Rank Indicator (RI), a Precoding Matrix Indicator (PMI), and a Channel Quality Indicator (CQI), for example. Compared to the CSI reporting in the normal CSI feedback, the CSI reporting in the high resolution feedback further includes beam information that indicates one or more beams that reflect better channel states, which are selected by the UE 10. When the BS 20 receives the CSI reporting from the UE 10, the BS 20 may perform precoding using the beam information. The beam information includes a beam index, a beam amplitude, a phase for beams and co-phase for two polarizations.

(Relationship Between Normal CSI and Advanced CSI Reporting Triggering)

According to one or more embodiments, the normal CSI feedback scheme and the high resolution CSI feedback scheme may be switched.

For example, the BS 20 may transmit CSI reporting type information designating the (normal) CSI reporting or the advanced CSI reporting to the UE 10. The UE 10 may perform the CSI reporting or the advanced CSI reporting based on the CSI reporting type information.

As another example, the UE 10 recommends the CSI reporting type to the BS 20. For example, the UE 10 notifies the BS 20 of the CSI reporting type indicating the (normal) CSI reporting or the advanced CSI reporting. For example, the notified CSI reporting type may be indicated as a CSI Type Indicator (CTI). Then, the BS 20 may overwrite a CSI reporting type stored in the BS 20 with the notified CSI reporting type. For example, the UE 10 may report the CSI indicated by the BS 20. On the other hand, the UE 10 may recommend the CSI reporting type using the CTI. The CTI may be transmitted together with RI/CRI/PTI.

(CSI Reporting Using PUCCH)

For example, for the CSI reporting in the high resolution CSI feedback, in case where (N₁, N₂)=(4, 4) and (O₁, O₂)=(8, 4), the overhead of feedback of the PMI is 14 bits (=2 bits+12 bits). N₁, N₂ are antenna port numbers for the first and second dimensions, respectively. O₁, O₂ are oversampling factors for the first and second dimensions, respectively. On the other hand, capacity of Physical Uplink Control Channel (PUCCH) format 2 is 11 bits, which is less than the overhead of feedback of the PMI.

In one or more embodiments of the present invention, the CSI reporting for the high resolution CSI feedback includes PMI that consists of the beam index and the amplitude.

According to one or more embodiments of the present invention, as shown in FIG. 2, one-step feedback of the PMI using PUCCH format 3/4/5 may be adapted for the high resolution CSI feedback. That is, the beam index and the amplitude are located in the same PUCCH format 3/4/5 and are simultaneously transmitted as the high resolution CSI feedback. In an example of FIG. 2, an amplitude field and a beam index field are located adjacent to each other in the PUCCH format 3/4/5. The amplitude field and the beam index field in the same PUCCH format 3/4/5 may not be located adjacent to each other. Thus, the UE 10 may perform the CSI reporting using the PUCCH format 3/4/5 in which the amplitude field and the beam index field of the PMI are not separated. As a result, according to one or more embodiments of the present invention, the PUCCH resource that is able to include larger CSI information may be applied for the CSI reporting in the high resolution CSI feedback.

As another example, according to one or more embodiments of the present invention, two-step feedback of the PMI using the PUCCH may be applied for the high resolution CSI feedback. For example, in the two-step feedback, the PMI may be divided into two parts. For example, the amplitude field and the beam index field of the PMI may be separated in the PUCCH resource. In one or more embodiments, a PMI1 indicates a PMI transmitted at the first time, and a PMI2 indicates a PMI transmitted after transmitting the PMI1.

Thus, according to one or more embodiments of the present invention, in the two-step feedback, when the UE 10 performs first CSI reporting and performs second CSI reporting after performing the first CSI reporting, the first CSI reporting includes one of the beam index and the amplitude. The second CSI reporting includes the beam index or the amplitude that is not included in the first CSI reporting.

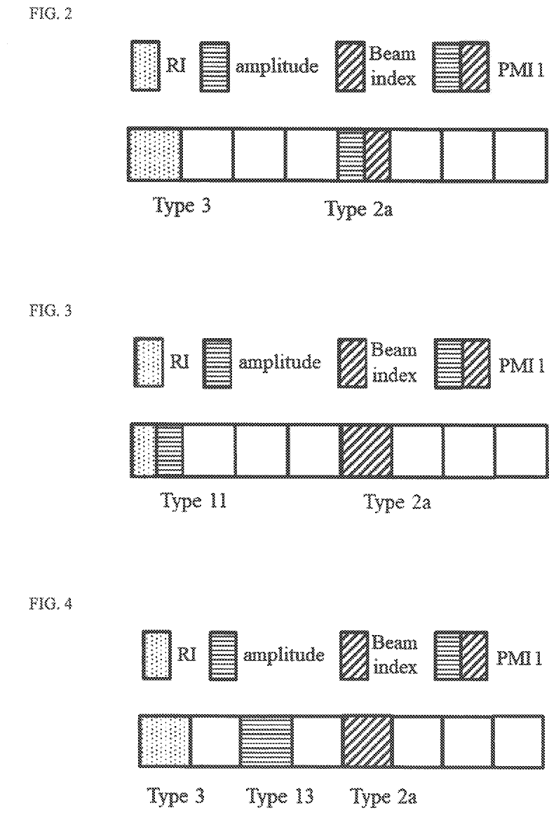

The BS 20 may obtain amplitude before obtain the PMI1 and PMI2. Therefore, the payload for beam index and PMI2 can adapt according to the value of amplitude. For example, if the amplitude for second beam is zero, the index and beam phase for second beam can be saved, as well as the polarization co-phase for the second beam. Furthermore, separately transmission of beam index and amplitude can reduce the overhead for once transmission, which makes PUCCH format 2 possible for feedback of the PMI. FIGS. 3 and 4 show examples of the PUCCH format 2 used for the two-step feedback of the PMI.

As shown in FIG. 3, an amplitude field and an RI field are located adjacent to each other in the PUCCH format 2. That is, the amplitude and the RI in the CSI reporting may be transmitted together from the UE 10 to the BS 20. The size of the amplitude field and the RI field may be a maximum of 3 bits. For example, payloads of W1 and W2 may be adjusted inn accordance with a value of the amplitude. For example, if the amplitude is zero, W1 is 8 bits and W2 is 2 bits for rank 1. Thus, both of the amplitude and the RI are included in the first CSI reporting or the second CSI reporting.

As shown in FIG. 4, a beam index field is independently located so that the beam index field is not adjacent to the RI and amplitude fields in the PUCCH format 2. Thus, the beam index in the CSI reporting may be independently transmitted from the UE 10 to the BS 20. In such a configuration, the maximum size is 11 bits, which is equal to the size of the PUCCH format 2. Thus, the amplitude is included in the first CSI reporting or the second CSI reporting that does not include the RI.

The PUCCH resources as shown in FIGS. 3 and 4 may reduce the overheads in each transmission and adjust the payload of W1 and W2 according to the value of the amplitude for beams so as to reduce the overall overheads.

(CSI Reporting Using PUSCH)

According to one or more embodiments of the present invention, the CSI reporting for the high resolution feedback may apply the two-step feedback scheme using a Physical Uplink Shared Channel (PUSCH).

For example, the amplitude and the beam index in the CSI reporting may be transmitted together. In this case, the maximum overheads in the PUSCH may be 14 bits. Thus, both of the beam index and the amplitude are included in the first CSI reporting or the second CSI reporting.

For example, the amplitude and the RI in the CSI reporting are transmitted together and separately from the beam index. Thus, both of the amplitude and the RI are included in the first advanced CSI reporting or the second advanced CSI reporting that does not include the beam index. In this case, the payload of the RI may be changed from 1 bit to 3 bits. Furthermore, the beam index may be adjusted in accordance with the value of the amplitude. As a result, the overheads of the CSI reporting may be reduced.

(Beam Number Reporting)

Typically, the number of beams in each beam combination may be defined in the LTE/NR standards. For example, in the LTE standard, the number of beams in each beam combination for CSI reporting is 2. For example, in the NR standard, the number of beams in each beam combination for CSI reporting is {2, 3, 4} (two, three, or four).

According to one or more embodiments of the present invention, when the number of beams in the beam combination is configured with the UE 10, the UE 10 may determine the number of beams in the beam combination based on the configured number of beams. The configured number of beams may be the number of beams in one beam combination that is allowed to be selected by the UE 10. The configured number of beams may be {2, 3, 4, 6, 8}. The configured number of beams is not limited to {2, 3, 4, 6, 8} and may be a predetermined number. The number of beams determined by the UE 10 may be less than or equal to the configured number of beams. For example, when the configured number of beams is 4, 4 beams may be combined in one beam combination. Then, the UE 10 may report the determined number of beams in the beam combination as the CSI feedback to the BS 20. For example, the number of beams in the beam combination reported to the BS 20 may be represented using the BNI.

Thus, according to one or more embodiments of the present invention, the CSI reporting includes the BNI to indicate the number of beams in the beam combination and the number of beams may be recommended from the UE 10 to BS 20. Then, the BS 20 may configure the number of beams following the UE's recommendation or overwrite the UE's recommendation.

For example, when the BS 20 notifies the UE 10 of the number of the beam in the beam combination, the UE 10 may determine the number of beams in the beam combination that is less than or equal to the number of beams notified by the BS 20. The number of beams in the beam combination reported to the BS 20 may be referred to the number of amplitude coefficients or the number of non-zero wideband amplitude coefficients. For example, the number of amplitude coefficients may not be equal to zero.

As a result, unnecessary feedback overheads of the PMI can be reduced.

As another example, when the BS 20 notify the UE 10 of the number of beams in a beam combination, the UE 10 may not determine the number of beams in the beam combination. That is, the number of beams in the beam combination may be configured by the BS 20 without the UE's recommendation.

(PUCCH Reporting Type Payload size per PUCCH Reporting Mode and Mode State)

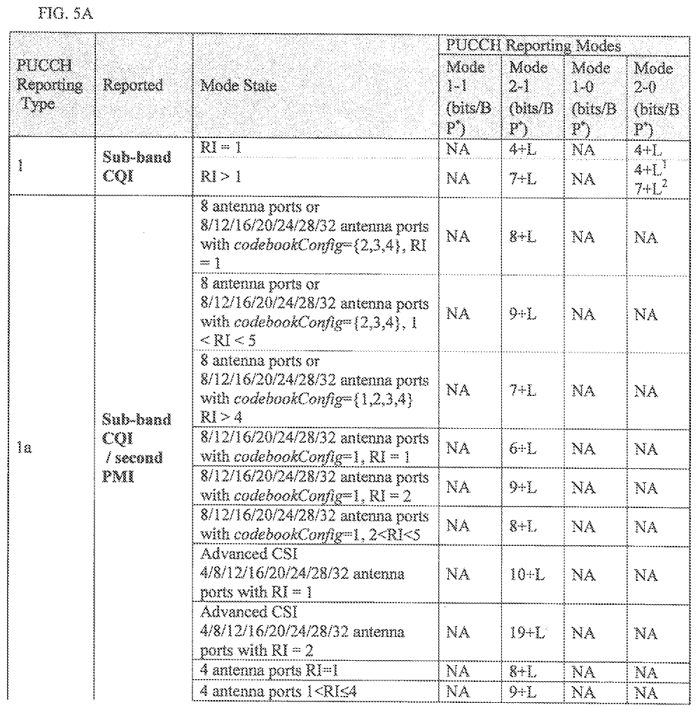

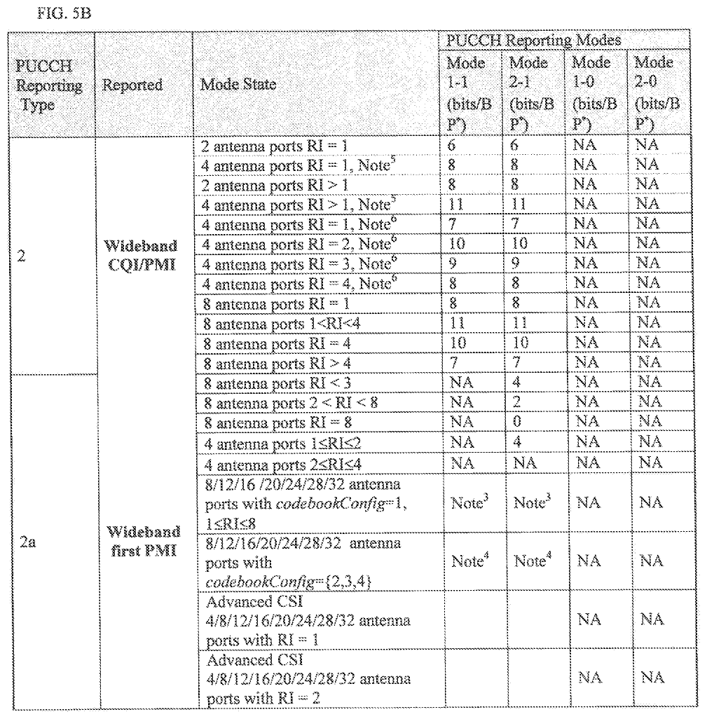

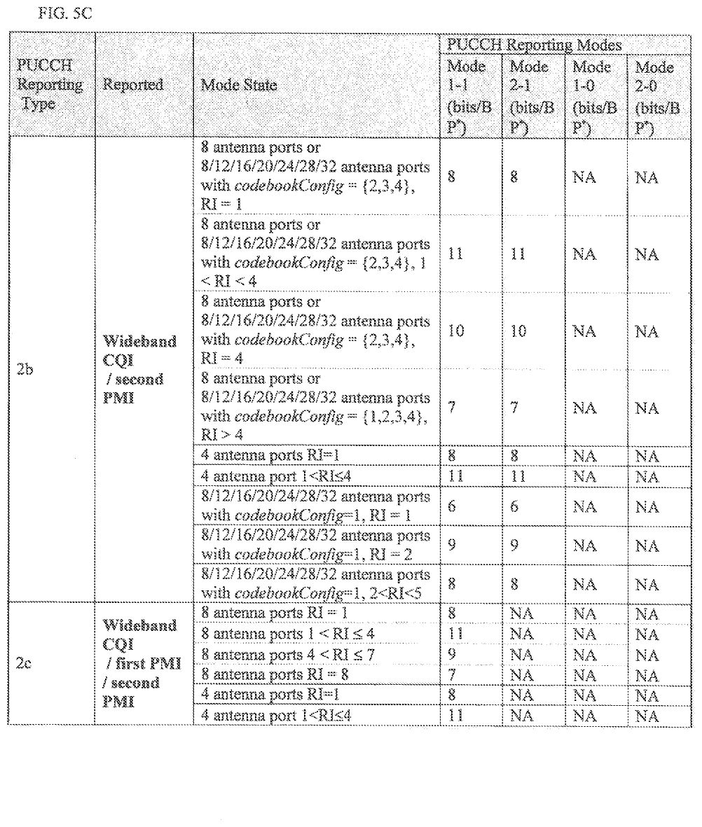

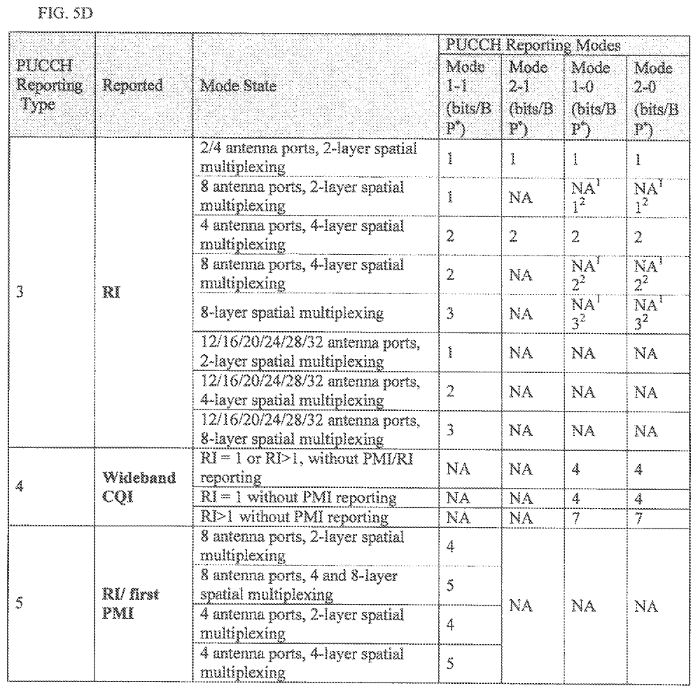

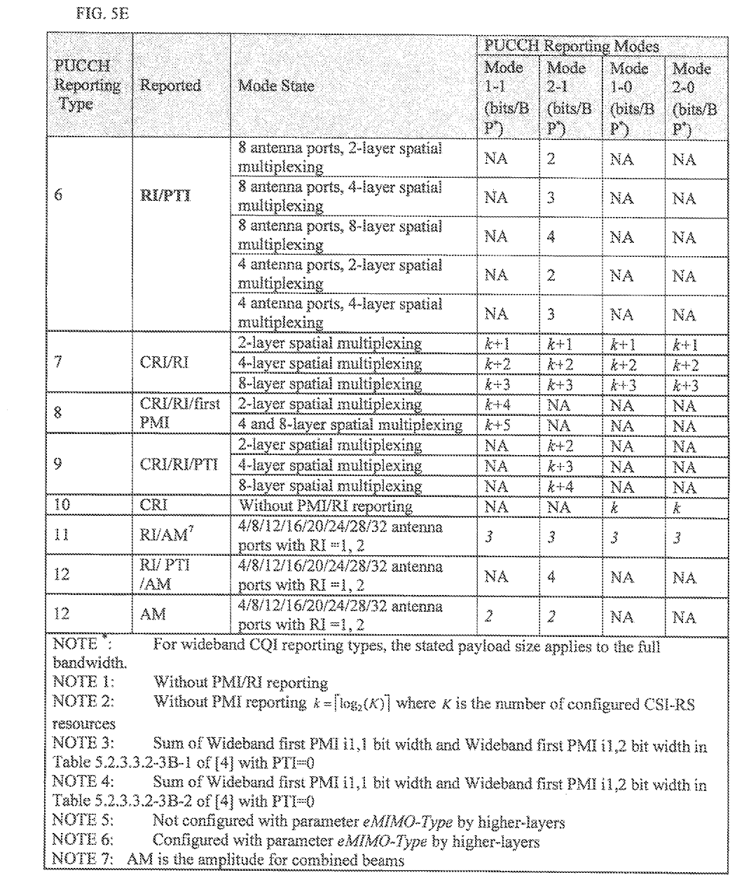

FIGS. 5A-5E are tables showing the PUCCH reporting type payload size per PUCCH reporting mode and mode state for the high resolution CSI feedback according to one or more embodiments of the present invention.

(Subsampling Codebook for Overhead Reduction)

Methods of subsampling for high payload transmission using the PUCCH format will be described below. The capacity of the PUCCH format may be limited. For example, more than 11 bits are to be transmitted using the PUCCH format 2.

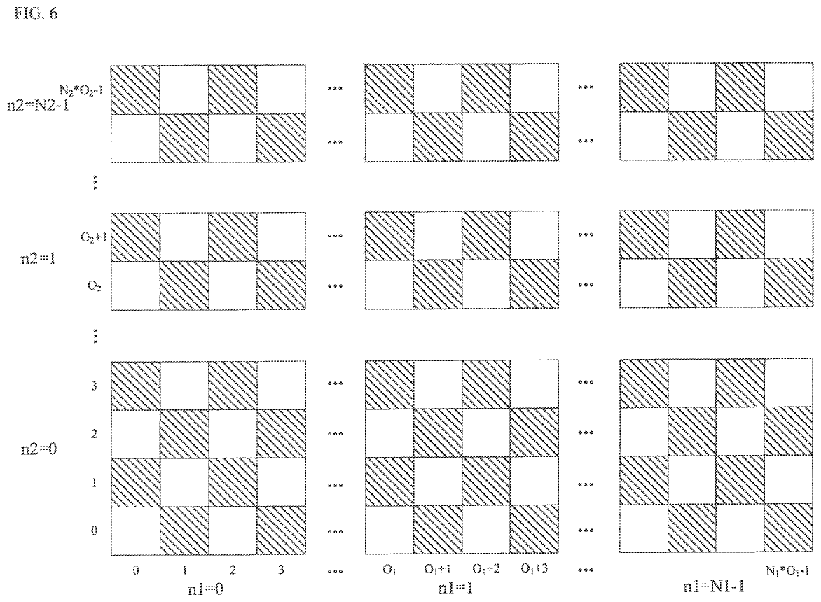

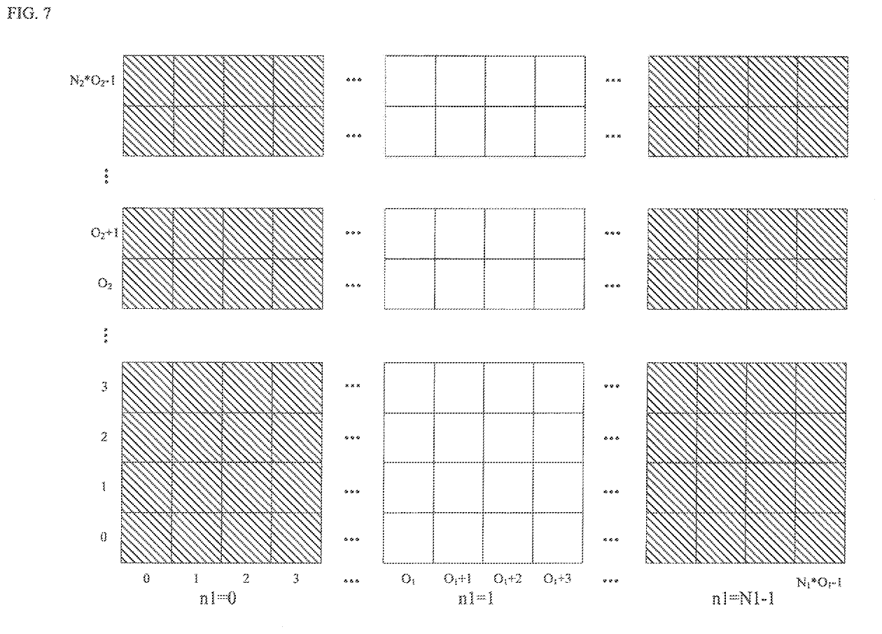

FIG. 6 is a diagram showing a method of selecting beams with a staggered pattern. For example, the UE 10 may select beams corresponding to resources arranged with a staggered pattern.

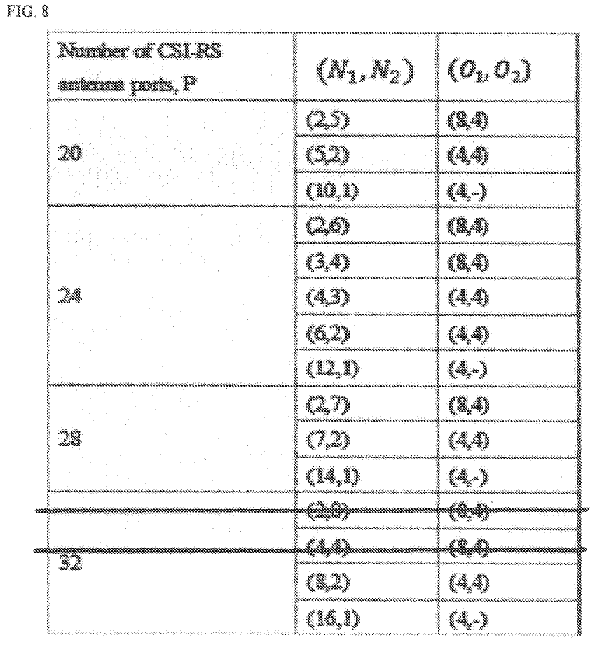

FIG. 7 is a diagram showing a method of selecting beams with a high selection frequency (high use frequency). For example, the UE 10 may select beams corresponding to high use frequency resources.

(Restriction of Oversampling Factor and Antenna Ports Combinations)

FIG. 8 is a diagram showing an example of a method of restricting oversampling factor and antenna ports combinations. For example, part of the oversampling factor and antenna ports combinations may be removed. In an example of FIG. 8, the combinations of (N₁, N₂)=(2, 8), (O₁, O₂)=(8, 4) and (N₁, N₂)=(4, 4), (O₁, O₂)=(8, 4) corresponding to the number of the CSI-RS antenna ports “32” may be removed in the table.

(Beam Pattern Selection)

There may be one or more beam patterns for the high resolution CSI feedback to improve coverage. According to one or more embodiments of the present invention, the UE 10 may transmit information including the RI, the number of beams in a beam combination, and the beam pattern, to the BS 20. The beam pattern may be determined based on the RI, the BNI, and a Beam Pattern Indicator (BPI), which are transmitted to the BS 20.

For example, when a single beam pattern is predefined, the UE 10 may not select the beam pattern and may select the rank and the CSI feedback type. The rank is specified based on the RI. The feedback type is specified based on the CTI.

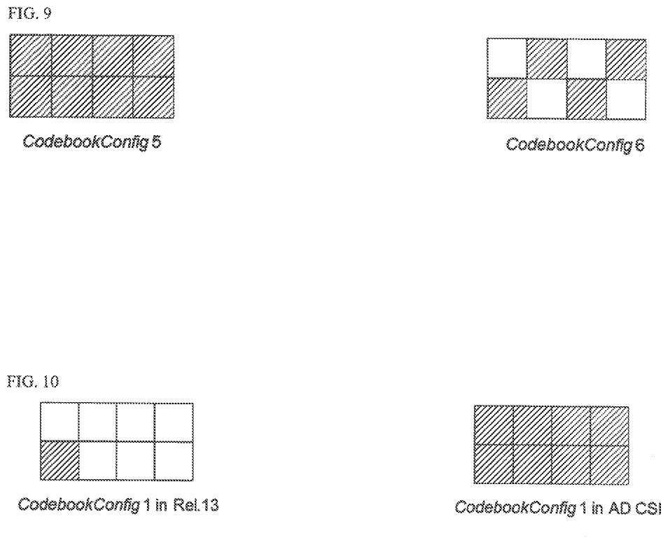

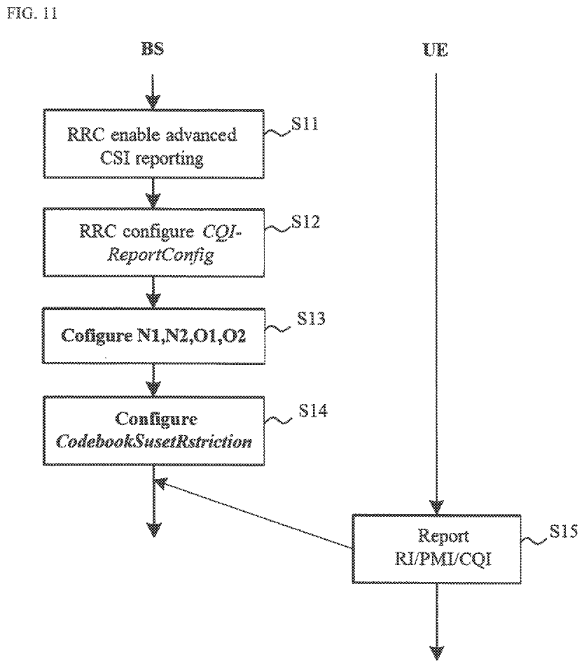

For example, the BS 20 may notify the UE 10 of the beam pattern indication. FIG. 9 is a diagram showing an example of beam pattern selection parameter CodebookConfig from 1, 2, 3, 4 to 1, 2, 3, 4, 5, 6, . . . . CodebookConfig5 and CodebookConfig6 represents new beam patterns in high resolution CSI feedback. FIG. 10 is a diagram showing an example of newly designed CodebookConfig1,2,3,4, which represents new beam patterns in the high resolution CSI feedback.

As another example of the beam pattern selection, the UE 10 may select the beam pattern and transmit the BPI to the BS 20. In such a case, the RI and a CSI-RS Resource Indicator (CRI) may be transmitted together from the UE 10 to the BS 20 as the high resolution CSI feedback.

FIG. 11 is a diagram showing an example of a feedback procedure without beam pattern selection according to one or more embodiments of the present invention. As shown in FIG. 11, the UE 10 may not perform the beam pattern selection.

At step S1, the BS 20 may enable the advanced CSI reporting using Radio Resource Control (RRC) signaling. At step S12, the BS 20 may configure CQI ReportConfig using the RRC signaling. At step S13, the BS 20 may configure N₁, N₂, O₁, O₂. At step S14, the BS 20 may configure CodebookSusetRestriction.

At step S15, the UE 10 may perform the CSI reporting including the RI, PMI, and the CQI.

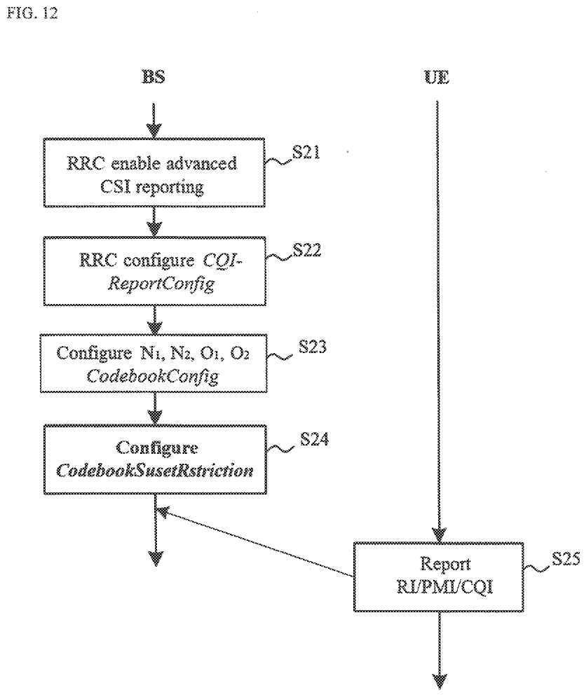

FIG. 12 is a diagram showing an example of a feedback procedure with beam pattern selection according to one or more embodiments of the present invention. The BS 20 may enable the advanced CSI reporting, more beam patterns and configure the beam pattern by CodebookConfig or CodebookSubsetRestriction.

At step S21, the BS 20 may enable the advanced CSI reporting using Radio Resource Control (RRC) signaling. At step S22, the BS 20 may configure CQI ReportConfig using the RRC signaling. At step S23, the BS 20 may configure N₁, N₂, O₁, O₂ using CodebookConfig. At step S24, the BS 20 may configure CodebookSusetRestriction.

At step S25, the UE 10 may perform the CSI reporting including the RI, PMI, and the CQI based on indications from the BS 20.

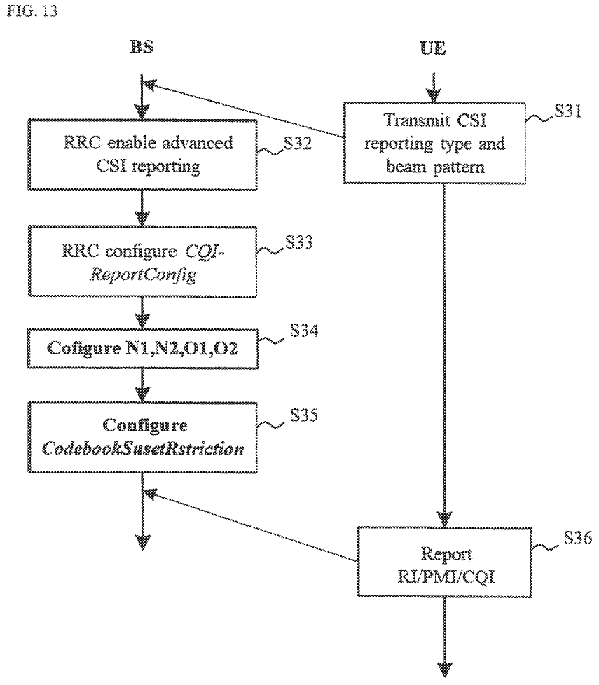

FIG. 13 is a diagram showing an example of a feedback procedure with beam pattern selection according to one or more embodiments of the present invention. The BS 20 may enable the advanced CSI reporting and the UE 10 may recommend the CSI reporting type, beam pattern, and then, the BS 20 can overwrite the UE's recommendation or not.

At step S31, the UE 10 may estimate the channel state and transmit the CSI reporting type and the beam pattern which is represented by the BPI to the BS 20. At the step S31, the number of beams in the beam combination represented by the BNI.

At step S32, the BS 20 may enable the advanced CSI reporting using the RRC signaling. At step S33, the BS 20 may configure CQI ReportConfig using the RRC signaling. At step S34, the BS 20 may configure N₁, N₂, O₁, O₂. At step S35, the BS 20 may configure CodebookSusetRestriction.

At step S36, the UE 10 may perform the CSI reporting including the RI, PMI, and the CQI based on indications from the BS 20.

For further improve the quantization resolution, the combination beam number may increase. In that case, there may be combination beam number selection, in addition to beam pattern selection. In one or more embodiments of the present invention, the UE 10 may recommend the beam combination number and beam pattern using the BNI and the BPI.

(Configuration of Base Station)

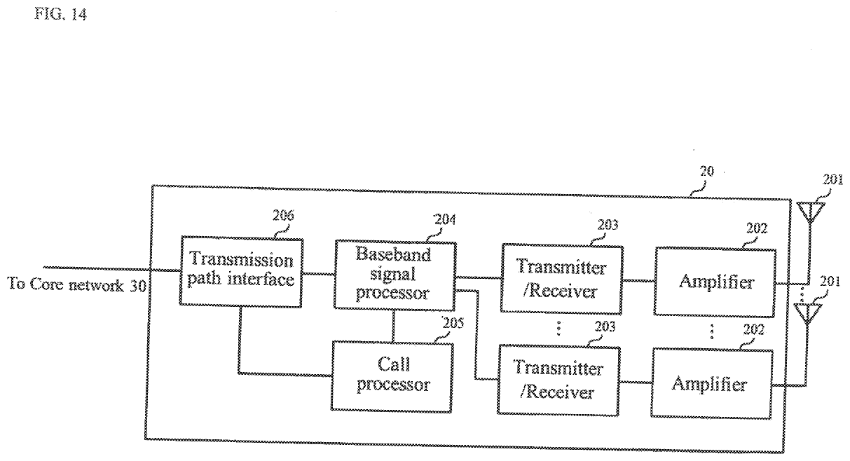

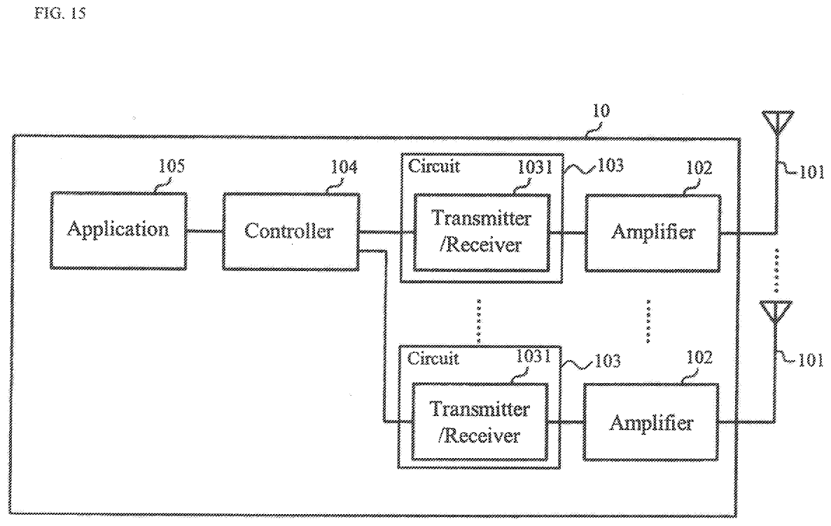

The BS 20 according to one or more embodiments of the present invention will be described below with reference to FIG. 14. FIG. 14 is a diagram illustrating a schematic configuration of the BS 20 according to one or more embodiments of the present invention. The BS 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the BS 20 to the UE 20 is input from the core network 30, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., RRC signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the BS 20, radio frequency signals are received in each antenna 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network 30 through the transmission path interface 206. The call processor 205 performs call processing such as setting up and releasing a communication channel, manages the state of the BS 20, and manages the radio resources.

(Configuration of User Equipment)

The UE 10 according to one or more embodiments of the present invention will be described below with reference to FIG. 15. FIG. 15 is a schematic configuration of the UE 10 according to one or more embodiments of the present invention. The UE 10 has a plurality of UE antennas 101, amplifiers 102, the circuit 103 comprising transceiver (transmitter/receiver) 1031, the controller 104, and an application 105.

As for DL, radio frequency signals received in the UE antennas 101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

One or more embodiments of the present invention may include one or more of the following advantages.

One or more embodiments of the present invention provide new feedback types to reduce the overhead for once transmission and adapt the subsequent feedback payload to reduce the overall overhead. As a result, the legacy feedback type may be extended to include feedback parameters for the high resolution CSI feedback.

One or more embodiments of the present invention provide a method using the beam pattern indication from the BS 20 to acquire better coverage.

One or more embodiments of the present invention provide a method using the UE selection beam pattern and beam number selection to better reflect channel state.

The feedback types according to one or more embodiments of the present invention may be based on two steps feedback, which split W1 feedback into two parts: amplitude is feedback in the first part, which impacts the second part feedback: the overhead for beam index. By this way, the overhead for once feedback and overall feedback can be reduced according to the value of beam amplitude.

In one or more embodiments of the present invention, in the method using the beam pattern and combination beam number selection, the beam pattern and combination beam number selection may be performed by the UE 10.

One or more embodiments of the present invention provide a method for codebook subsampling to reduce overhead

One or more embodiments may be used for CSI feedback and the UE 10 to obtain reliable channel state information to optimize beamforming and MIMO (e.g., SU-MIMO or MU-MIMO) to provide high data rate, high reliability service.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A method of Channel State Information (CSI) reporting in a wireless communication system, the method comprising:
performing, with a user equipment (UE), advanced CSI reporting based on a high resolution CSI feedback scheme,
wherein the advanced CSI reporting includes a beam index that identifies each of beams and amplitude of the beam corresponding to the beam index.

2. The method according to claim 1,
wherein the performing performs the advanced CST reporting using a Physical Uplink Control Channel (PUCCH) format 3/4/5, and
wherein the beam index and the amplitude are located in the PUCCH format 3/4/5.

3. The method according to claim 1,
wherein the performing performs first advanced CSI reporting,
wherein the performing performs second advanced CSI reporting after performing the first advanced CSI reporting,
wherein the first advanced CSI reporting includes one of the beam index and the amplitude, and
wherein the second advanced CSI reporting includes the beam index or the amplitude that is not included in the first advanced CSI reporting.

4. The method according to claim 3,
wherein the performing performs the first advanced CSI reporting and the second advanced CSI reporting using a PUCCH format 2, and
wherein both of the amplitude and a Rank Indicator (RI) are included in the first advanced CSI reporting or the second advanced CSI reporting.

5. The method according to claim 3,
wherein the performing performs the first advanced CSI reporting and the second advanced CSI reporting using a PUCCH format 2, and
wherein the amplitude is included in the first advanced CSI reporting or the second advanced CSI reporting that does not include an RI.

6. The method according to claim 3,
wherein the performing performs the first advanced CSI reporting and the second advanced CSI reporting using a PUCCH format 2, and
wherein when a value of the amplitude is zero, the first advanced CSI reporting and the second advanced CSI reporting do not include the beam index corresponding to the amplitude.

7. The method according to claim 3,
wherein the performing performs the first advanced CSI reporting and the second advanced CSI reporting using a Physical Uplink Shared Channel (PUSCH), and
wherein both of the beam index and the amplitude are included in the first advanced CSI reporting or the second advanced CSI reporting.

8. The method according to claim 3,
wherein the performing performs the first advanced CSI reporting and the second advanced CSI reporting using a PUSCH, and
wherein both of the amplitude and an RI are included in the first advanced CSI reporting or the second advanced CSI reporting that does not include the beam index.

9. The method according to claim 1, further comprising;
selecting, with the UE, beams corresponding to resources arranged with a staggered pattern,
wherein the advanced CSI reporting includes the beam indexes associated with the selected beams.

10. The method according to claim 1, further comprising;
selecting, with the UE, beams corresponding to high use frequency resources,
wherein the advanced CSI reporting includes the beam indexes associated with the selected beams.

11. The method according to claim 1, further comprising;
restricting, with the UE, oversampling factor and antenna ports combinations, and
selecting, with the UE, the oversampling factor and the antenna ports combinations.

12. The method according to claim 1, further comprising;
determining, with the UE, a first number of beams in a beam combination,
wherein the advanced CSI reporting includes the first number.

13. The method according to claim 12, further comprising;
notifying, with the BS, the UE of a second number of beams in a beam combination,
wherein the determining determines with the UE, the first number that is less than or equal to the second number.

14. The method according to claim 1, further comprising;
transmitting, from the UE to the BS, information including an RI, a number of beams in a beam combination, and the beam pattern.

15. A method of Channel State Information (CSI) reporting in a wireless communication system, the method comprising:
performing, with a user equipment (UE), CSI reporting to a base station (BS) based on a normal CSI feedback scheme or advanced CSI reporting based on a high resolution CSI feedback scheme,
wherein the normal CSI feedback scheme and the high resolution CSI feedback scheme is switched.

16. The method according to claim 15, further comprising,
transmitting, from the BS to the UE, CSI reporting type information designating the normal CSI feedback scheme or the high resolution CSI feedback scheme,
wherein the performing performs the CSI reporting or the advanced CSI reporting based on the CSI reporting type information.

17. The method according to claim 15, further comprising,
notifying, with the UE, the BS of to the UE, a CSI reporting type indicating the normal CSI feedback scheme or the high resolution CSI feedback scheme, and
overwriting, with the BS, a CSI reporting type stored in the BS with the notified CSI reporting type.
